(19) United States
(12) Patent Application Publication
(10) Pub. No.: US 2018/0356650 A1
(43) Pub. Date: Dec. 13, 2018

(54) LIGHTWEIGHT SPECTACLE LENS

(71) Applicant: HON HAI PRECISION INDUSTRY CO., LTD., New Taipei (TW)

(72) Inventor: HSIU-WEN CHIEN, New Taipei (TW)

(21) Appl. No.: 15/637,124

(22) Filed: Jun. 29, 2017

(30) Foreign Application Priority Data
Jun. 12, 2017 (CN) 201710438507.9

(51) Int. Cl. G02C 7/04; G02B 1/04

(52) U.S. Cl. CPC G02C 7/04; G02B 1/041

(57) ABSTRACT

A lightweight spectacle lens is disclosed. The spectacle lens is less prone to being cracked and scratched. The spectacle lens can be made of cyclic block copolymer or a mixture of cyclic block copolymer and polycarbonate and coated with one or more films for certain desirable characteristics.

### FIELD

The subject matter herein generally relates to optical aids, and to a lens for spectacles.

### BACKGROUND

People with poor eyesight usually wear glasses or contact lenses, so that they can see clearly. Contact lenses are convenient. However, human eyes will feel dry when contact lenses are worn for a long time, which can cause red-eye. Non-contact glass lenses are convenient. However, ordinary glass lenses are easy to crack and be scratched.

### BRIEF DESCRIPTION OF THE DRAWINGS

Implementations of the present technology will now be described, by way of example only, with reference to the attached figures.

FIG. 1 is an isometric view of a spectacle lens in accordance with one exemplary embodiment.

FIG. 2 is a cross-sectional view taken along line II-II of FIG. 1.

FIG. 3 is a cross-sectional view of a spectacle lens in accordance with one exemplary embodiment.

FIG. 4 is a cross-sectional view taken along line IV-IV of FIG. 1.

FIG. 5 is a cross-sectional view of a spectacle lens in accordance with one exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

### Example 1

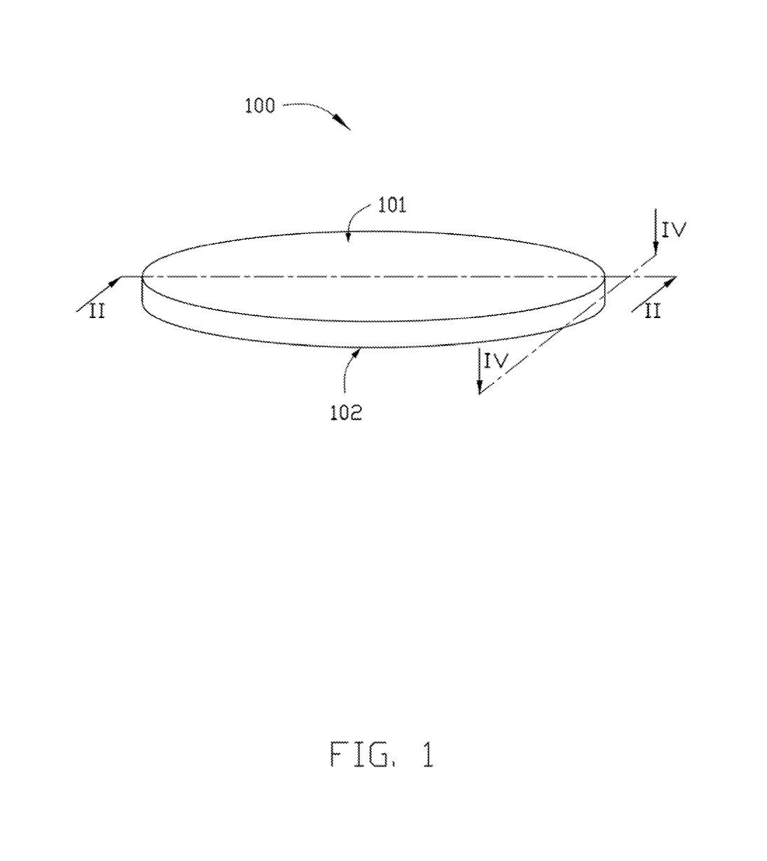

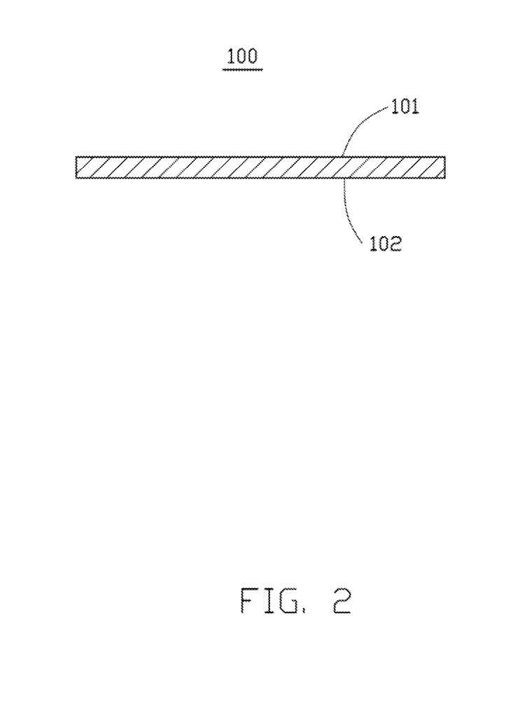

FIGS. 1-2 illustrate a lightweight spectacle lens 100 according to one embodiment. The spectacle lens 100 is substantially circular and the material of the spectacle lens 100 is cyclic block copolymer (CBC) or a mixture of cyclic block copolymer and polycarbonate (PC).

If the material of the spectacle lens is a mixture of cyclic block copolymer and polycarbonate, a weight ratio between the cyclic block copolymer and the polycarbonate is in a range from 45:55 to 98:2. Having the weight ratio in this range allows the spectacle lens 100 to have lightweight performance, strong ultraviolet-blocking property, lower risk of breaking, and better shock resistance.

The lightweight spectacle lens 100 comprises a front surface 101 and a rear surface 102. The front surface 101 is a spherical surface, or a non spherical surface, or a progressive surface, and the back surface 102 is a spherical surface, or an aspheric surface, or a progressive surface.

### Example 2

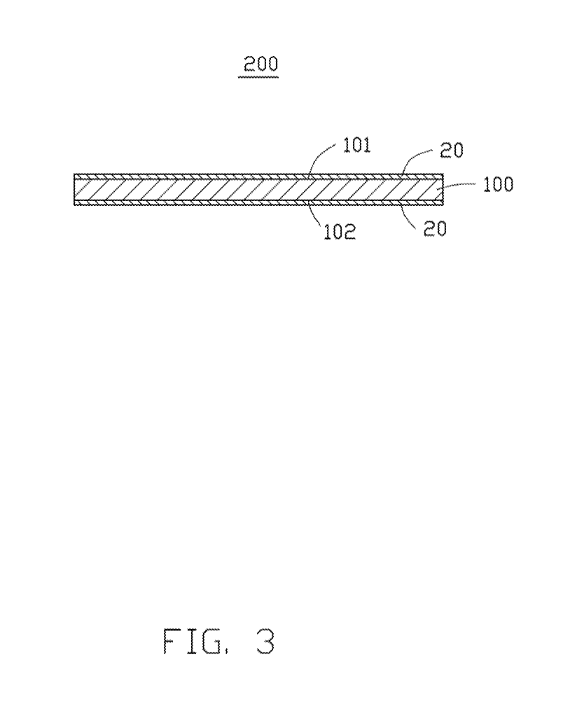

FIG. 3 illustrates a lightweight spectacle lens 200 according to one embodiment. The lightweight spectacle lens 200 in FIG. 3 is similar to the lightweight spectacle lens 100 in FIG. 2. The difference between the lightweight spectacle lens 200 and the lightweight spectacle lens 100 in FIG. 2 is that the lightweight spectacle lens 200 further includes a functional film 20. The functional film 20 may be formed on the front surface 101, the rear surface 102, or both. In the illustrated embodiment, the functional film 20 is formed on both the front surface 101 and rear surface 102. The functional film 20 may be a rigid film, an anti-smear film (to reduce fingerprints), an anti fogging film, a color film, and an anti reflection film, or any combination thereof.

### Example 3

The functional film is a single rigid film 20, the rigid film 20 has a high surface hardness and a strong adhesive strength. A high surface hardness means a high scratch resistance, and the rigid film 20 protects the lightweight spectacle lens 100 from scratches. The rigid film 20 is composed of a dopamine, a plurality of inorganic oxide particles, and a solvent. The rigid film 20 is formed by coating a mixture of a dopamine, and a plurality of inorganic oxide particles on surfaces of the spectacle lens 100.

The dopamine has a mass percentage of about 1% to about 40% of a total mass of the hard coating composition, the plurality of the inorganic oxide particles has a mass percentage of about 40% to about 80% of the total mass of the hard coating composition. The solvent has a mass percentage of about 5% to about 50% of the total mass of the hard coating composition.

The plurality of inorganic oxide particles is selected from particles of silica, zirconia, alumina, titanium, or any combination thereof. Particle diameter of the inorganic oxide particle is about 1 nm to about 1000 nm.

The solvent is water, an alcohol aqueous solution, or an oxidizing aqueous solution. The alcohol aqueous solution is a methanol aqueous solution, an ethanol aqueous solution, or a propanol aqueous solution, and the oxidizing aqueous solution is sodium periodate aqueous solution.

### Example 4

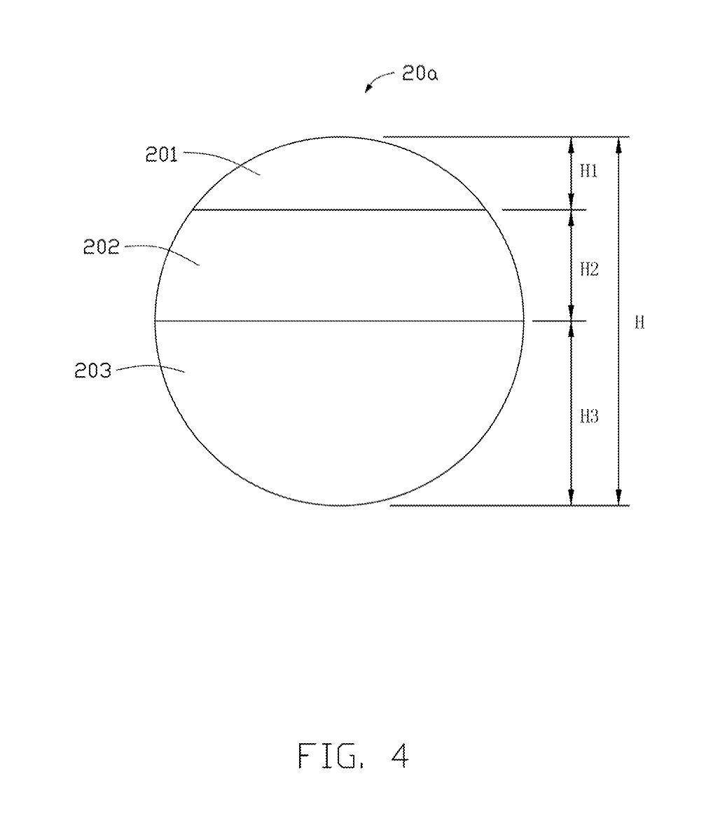

With reference to FIGS. 3 and 4, the functional film 20 is a single color film 20a. The color of the color film 20a gradually becomes lighter from top to bottom. In this exemplary embodiment, from top to bottom, the color film 20a is divided into a dark zone 201, a transition zone 202, and a light zone 203. The transparency of the dark zone 201 is about from 0% to 10%, the transparency of the transition zone 202 is about from 10% to 30%, and the transparency of the light zone 203 is about from 30% to 80%.

A height of the lightweight spectacle lens 200 from top to bottom is H, as shown in FIG. 4. A height of the dark zone 201 is H1, a height of the transition zone 202 is H2, and a height of the light zone 203 is H3. The H, H1, H2, and H3 satisfy the formulas 0.2H≤H1≤0.5H, 0.15H≤H2≤0.2H, and 0.3H≤H3≤0.7H.

In this exemplary embodiment, H1 is about equal to 0.5H, H2 is about equal to 0.17H, and H3 is about equal to 0.33H.

### Example 5

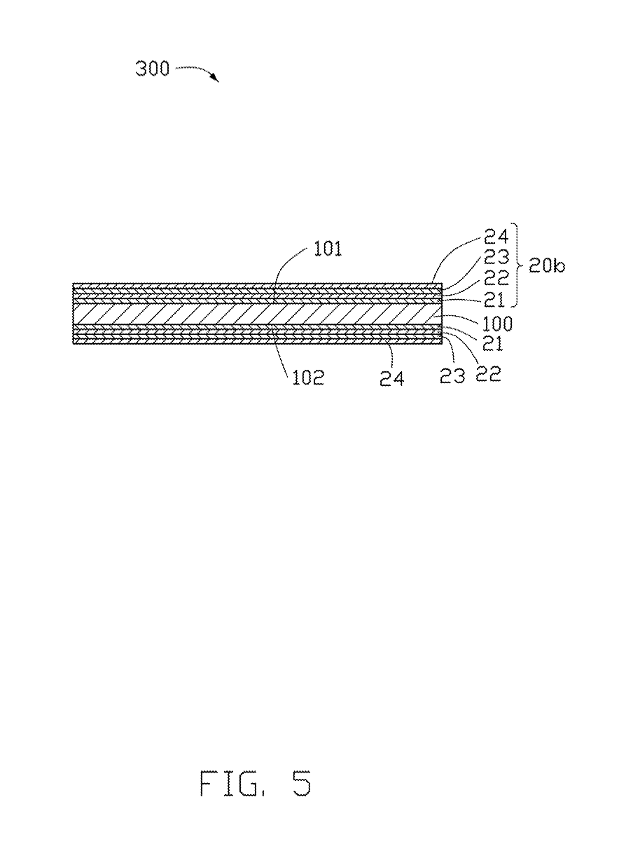

FIG. 5 illustrates a lightweight spectacle lens 300 according to one embodiment. The spectacle lens 300 in FIG. 5 is similar to the spectacle lens 200 in FIG. 3. The difference between the spectacle lens 300 and the spectacle lens 200 in FIG. 3 is that the functional film 20b is a combination of color film 21, a rigid film 22, an anti-reflective layer 23, and an anti-smear film 24.

In detail, the color film 21 is formed on front surface 101 and rear surface 102 of the spectacle lens 100. The rigid film 22 is formed on opposite surfaces of the color film 21 away from spectacle lens 100. The anti-reflective layer 23 is formed on opposite surfaces of the rigid film 22 away from the spectacle lens 100. The anti-smear film 24 is formed on opposite surfaces of the anti-reflective layer 23 away from the spectacle lens 100.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A lightweight spectacle lens comprising:
a material having cyclic block copolymer or a mixture of cyclic block copolymer and polycarbonate.

2. The lightweight spectacle lens of claim 1, wherein the material of the spectacle lens is the mixture of cyclic block copolymer and polycarbonate, and a weight ratio between the cyclic block copolymer and the polycarbonate is in a range from 45:55 to 98:2.

3. The lightweight spectacle lens of claim 1, wherein the spectacle lens comprises a front surface and a rear surface, the front surface is a spherical surface, a non spherical surface, or a progressive surface, and the back surface is a spherical surface, an aspheric surface, or a progressive surface.

4. The lightweight spectacle lens of claim 3, wherein the spectacle lens further comprises a functional film, and the functional film is formed on the front surface, the rear surface, or both.

5. The lightweight spectacle lens of claim 4, wherein the functional film is select from a group consisting of a rigid film, an anti-smear film, an anti fogging film, a color film and an anti reflection film or any combination thereof.

6. The lightweight spectacle lens of claim 5, wherein the functional film is a rigid film, and the rigid film is composed of a dopamine, a plurality of inorganic oxide particles, and a solvent.

7. The lightweight spectacle lens of claim 6, wherein the dopamine has a mass percentage of about 1% to about 40% of a total mass of the hard coating composition, the plurality of the inorganic oxide particles has a mass percentage of about 40% to about 80% of the total mass of the hard coating composition, the solvent has a mass percentage of about 5% to about 50% of the total mass of the hard coating composition.

8. The lightweight spectacle lens of claim 6, wherein the plurality of inorganic oxide particles is selected from particles of silica, zirconia, alumina, titanium, or any combination thereof.

9. The lightweight spectacle lens of claim 6, wherein a particle diameter of the inorganic oxide particle is about 1 nm to about 1000 nm.

10. The lightweight spectacle lens of claim 6, wherein the solvent is water, an alcohol aqueous solution, or an oxidizing aqueous solution.

11. The lightweight spectacle lens of claim 10, wherein the alcohol aqueous solution is a methanol aqueous solution, an ethanol aqueous solution, or a propanol aqueous solution, and the oxidizing aqueous solution is sodium periodate aqueous solution.

12. The lightweight spectacle lens of claim 5, wherein the functional film is a color film, and from top to bottom, the color film is divided into a dark zone, a transition zone, and a light zone; the transparency of the dark zone is about from 0% to 10%, the transparency of the transition zone is about from 10% to 30%, and the transparency of the light zone is about from 30% to 80%.

13. The lightweight spectacle lens of claim 12, wherein a height of the spectacle lens from top to bottom is H, a height of the dark zone is H1, a height of the transition zone is H2, and a height of the light zone is H3; wherein the H, H1, H2, and H3 satisfy the formulas: 0.2H≤H1≤0.5H, 0.15H≤H2 ≤0.2H, and 0.3H≤H3≤0.7H.
